(19) United States
(12) Patent Application Publication
(10) Pub. No.: US 2014/0028588 A1
(43) Pub. Date: Jan. 30, 2014

(54) INFRARED DETECTION DEVICE AND METHOD WITH PREDICTABLE MULTITOUCH TOUCH CONTROL

(71) Applicant: ECE, Paris (FR)

(72) Inventors: Sébastien NEVEU, Paris (FR); Romain De BOSSOREILLE, Paris (FR); Remi ANDREOLETTI, Paris (FR)

(21) Appl. No.: 13/936,004

(22) Filed: Jul. 5, 2013

(30) Foreign Application Priority Data
Jul. 6, 2012 (FR) 12 56557

(51) Int. Cl. G06F 3/041

(52) U.S. Cl. CPC G06F 3/0416
USPC 345/173

(57) ABSTRACT

The device comprises at least one frame, a first group of infrared ray emitters and a second group of infrared ray emitters, said groups framing a touch interaction space, the scanning of this space being performed by the successive activations of the emitters of the first group then of the second group, wherein, for the first group of emitters and for the second group of emitters: each emitter is associated with a subgroup of receivers, the receivers of said subgroup being arranged facing said emitter; the scanning cycles are initiated according to set time periods, a scanning cycle comprising a complete scan of constant duration according to the first group of emitters and a complete scan of constant duration according to the second group of emitters; all of the emitted rays not received defining one or more shadow areas.

### CROSS-REFERENCE TO RELATED APPLICATION

This application claims priority to foreign French patent application No. FR 1256557, filed on Jul. 6, 2012, the disclosure of which is incorporated by reference in its entirety.

### FIELD OF THE INVENTION

The present invention relates to a predictable multitouch touch control device and method. It applies notably for display screens used to equip pylons or instrument panels of aircraft cockpits.

### BACKGROUND

Embodied avionic devices are increasingly using touch screen solutions. Touch-type solutions are preferred to the traditional control interfaces of electromechanical key or mouse type, notably because of the ergonomic facilities provided by these solutions as well as their reconfigurability and space saving. A number of display devices with which the aircraft cockpits are equipped may be candidates for touch controls, that is to say combining the display of the information on the screen and the on-screen control by simple touch (or single touch) or multiple touches (or multitouch).

Such is notably the case with the instrument panel used for the preparation and tracking of flights, called EFB panel, which stands for “Electronic Flight Bag”. This panel, placed flat on the central pylon of the cockpit replaces the earlier paper documents comprising notably the maps, approach maps, checklists, flight and operation manuals, fuel level, etc. All this various information is displayed according to the command applied by the pilot by means of an HMI menu available on the screen and via traditional interfaces as described previously. The display of the data is managed by processing means incorporated in the screen or, more generally, in a module associated with the screen, these means communicating with the control interfaces.

All the screens of the cockpit may also be candidates for a solution of the touch-control type.

In a touch solution, the control of the displays controlled by touches on the screen. Control by single touch makes it possible, for example, to pick an object from a displayed menu or a place on a map. The multitouch solution makes it possible to enrich the touch control. In particular, the movement of the fingers, two fingers for example, can contain additional, richer information. Multitouch control thus makes it possible to adopt multiple-finger gestures, each gesture corresponding to a well-defined information item.

A number of touch-screen technologies are known. Types that can notably be cited include:
capacitive;
resistive;
infrared
   Each of these technologies makes it possible, through particular algorithms, to manage and detect by single-touch or by multitouch.

A technology that is widely used is capacitive control. This is found, for example, in the control of the display of the screens of smartphones or multifunction software tablets.

Capacitive control is ill-suited to an avionics environment which is subject to various disturbances such as electromagnetic interference, notably. The touches are infact detected by the detection of electromagnetic interference generated by these very touches. Thus, capacitive control is unable to ensure dependability without effective counterattacking means that are complex and costly to implement.

One solution that is insensitive to the abovementioned disturbances is infrared touch control, which is known to be resistant. For a multitouch application, it does not, however, allow, with the current solutions, for predictable touch control. In other words, the processing time to locate the position of at least two touches on the screen is indeterminate notably because of the number of touches and the size of these very touches. This indeterminacy is incompatible with an aeronautical application which requires accuracy and predictability.

### SUMMARY OF THE INVENTION

One aim of the invention is notably to allow for the use of a touch screen of infrared type that makes it possible to apply predictable and accurate multitouch controls.

To this end, the subject of the invention is a touch control device of the type with infrared barriers comprising at least one frame, a first group of infrared ray emitters facing a first group of receivers in a first direction x and a second group of infrared ray emitters facing a second group of receivers in a second direction y, said groups framing a touch interaction space, the scanning of this space being performed by the successive activations of the emitters of the first group then of the second group, the intrusion of an opaque object, called touch, inside the touch interaction space provoking an interruption of emitted rays, characterized in that, for the first group of emitters and for the second group of emitters:
each emitter is associated with a subgroup of receivers intended to pick up the rays emitted by said emitter, the receivers of said subgroup being arranged facing said emitter, the set of all the pairs (k, k+j) scanned being stored, where k represents the number of an emitter in the group and k+j the number of one of its associated receivers;
the scanning cycles are initiated according to set time periods, a scanning cycle comprising a complete scan of constant duration according to the first group of emitters and a complete scan of constant duration according to the second group of emitters, a pair (k, k+j) being assigned to each ray emitted and received, k being the number of the emitter and k+j the number of the receiver;
   all of the emitted rays not received, identified by their pairs (k, k+j), defining one or more shadow areas, the detection of one or more touches being performed by the analysis of these areas by said processing means.

In a particular embodiment, −p<j<p, where p is a positive integer, j taking some or all of the values between −p and p, 2p−F1 being less than the number of receivers of the group.

A first series of shadow areas is, for example, obtained in the direction x, and a second series of shadow areas is, for example, obtained in the direction y, an unscanned space containing at least one touch, said analysis being performed on the space or spaces obtained by the intersection of the first and second series of areas.

The processing means differentiate, for example, the real touches from phantom touches on a criterion of sizes, forms, extent of these shadow areas and/or by comparison with the preceding state of the touches.

The emitted rays can be frequency-modulated, the ray received by a receiver Rk+j being associated with an emitter Rk according to the number of said receiver Rk+j and the verification of said modulation.

The processing means are, for example, incorporated in the device, these processing means transmitting the positions of the touches to display interfaces.

The device can be used to equip an aircraft cockpit.

Also the subject of the invention is a touch control method of the type with infrared barriers, said method using a first group of infrared ray emitters facing a first group of receivers in a first direction x and a second group of infrared ray emitters facing a second group of receivers in a second direction y, said groups framing a touch interaction space, the scanning of this space being performed by the successive activations of the emitters of the first group then of the second group, the intrusion of an opaque object, called touch, inside the touch interaction space provoking an interruption of emitted rays, characterized in that, for the first and for the second group of emitters:
each emitter has associated with it a subgroup of receivers intended to pick up the rays emitted by said emitter, the receivers of said subgroup being arranged facing said emitter, the set of all the pairs (k, k+j) scanned being stored, where k represents the number of an emitter in the group and k+j the number of one of its associated receivers;
the scanning cycles are initiated according to set time periods, a scanning cycle comprising a complete scan of constant duration according to the first group of emitters and a complete scan of constant duration according to the second group of emitters, a pair (k, k+j) being assigned to each ray emitted and received, k being the number of the emitter and k+j the number of the receiver;
   all of the emitted rays not received, identified by their pairs (k, k+j), defining one or more shadow areas, the detection of one or more touches being performed by an analysis of these areas.

### BRIEF DESCRIPTION OF THE DRAWINGS

Other features and advantages of the invention will become apparent from the following description, given in light of the appended drawings which represent:

FIGS. 1a and 1b, an illustration of the principle of operation of a touch frame by infrared barrier detection;

FIG. 2, an illustration of the ambiguity in the detection of a multitouch control;

FIGS. 3a and 3b, an illustration of an infrared ray scanning mode in a device according to the invention;

FIGS. 4a and 4b, an illustration of the application of a multitouch control in the case of the preceding scan;

FIG. 5, an example of unambiguous detection.

### DETAILED DESCRIPTION

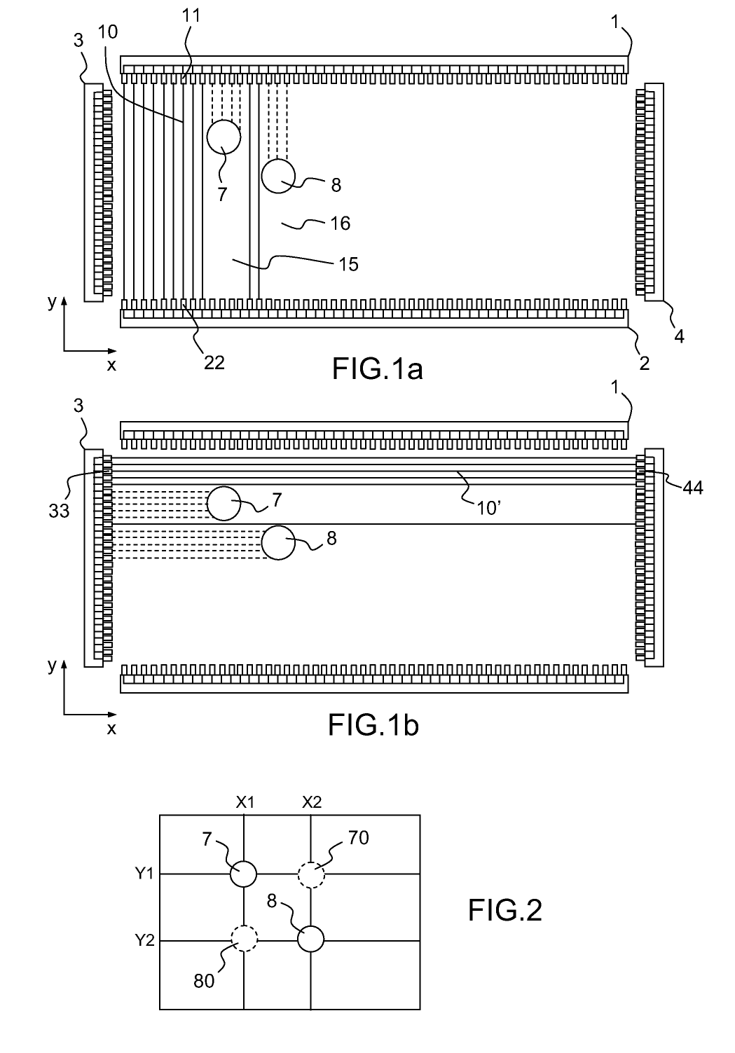

FIGS. 1a and 1b illustrate the principle of operation of a touch frame based on infrared barrier detection as defined by the prior art, as well as the problem of the measurement uncertainty in a case of the application of two touches 7 and 8, with no particular processing algorithm, coupled with the problem of lack of predictability.

Only the emitters, the receivers and the infrared rays are represented.

The touch frame is neither a screen nor a “touch pad”, but indeed a frame in which are installed groups of emitters 1, 3 and groups of receivers 2, 4. If necessary, this frame may be installed on a pad to provide a support for the touches and/or to propose a display. The groups of emitters create a mesh of infrared rays that are invisible to the users.

A first group of emitters 1 is placed on a first side of the frame, for example in the lengthwise direction if the latter is rectangular, and a first group of receivers 2 is placed on the opposite side. This first group of receivers 2 is associated with the first group of emitters 1 in as much as it is intended to pick up the infrared rays 10 emitted by its emitters. More particularly, an emitter 11 is associated with a single receiver 22. The latter, placed facing its associated emitter, is designed to pick up the beam 10 emitted by that emitter 11. The direction of these two groups is identified by a first axis, axis x, which will also hereinafter be called horizontal axis.

A second group of emitters 3 is placed at right angles to the first group 1. A second group of receivers 4 is placed on the opposite side, associated with the second group of emitters and therefore intended to pick up the infrared rays 10′ emitted. The direction of these second groups is identified by a second axis, y axis, that can likewise be called vertical axis. As for the first groups, an emitter 33 is associated with a single receiver 44.

With the control being designed as two-touch, the first group of emitters performs a first scan of infrared rays 10 on the x axis until two series of interrupted rays are detected, making it possible to determine the positions of the x axis, or horizontal axis, of the points of impact of the touches. In practice, during an impact, a shadow 15, 16 is created on the receivers which interrupts the passage of the infrared rays. The receivers on the x axis deprived of the infrared rays detect the coordinates of these points of impact on the x axis. The X coordinates of a point of impact, corresponding to the positions or numbers of the receivers deprived of light rays, can then be transmitted to processing means. The principle of detection on the y, or vertical, axis is the same based on the second groups of emitters 2 and receivers 4.

These detection modes lack predictability since the measurement processing time depends in particular on the position of the points of impact. To this problem of lack of predictability is added the problem of uncertainty concerning the measurements.

During the horizontal scan, on x, two coordinates of the centre of the points of impact, X1 and X2, are detected. During the vertical scan, on y, two coordinates of the centre of the points of impact, Y1 and Y2, are detected. Four possible pairs of coordinates, (X1, Y1), (X1, Y2), (X2, Y1) and (X2, Y2), are therefore obtained, for only two real points of impact.

FIG. 2 illustrates this uncertainty. The two passages illustrated in FIGS. 1a and 1b lead in fact to the detection of four areas 7, 8, 70, 80, of the same dimensions, associated with the four pairs of central coordinates (X1, Y1), (X1, Y2), (X2, Y1), (X2, Y2) deduced from the beam interruptions. Alongside the detection of the two real touch points 7 and 8, there is the detection of two fictitious, or phantom, touch points, 70 and 80.

The vertical and horizontal passages of FIGS. 1a and 1b do not therefore make it possible to dissociate the positions of the two real touch points from the two fictitious touch points.

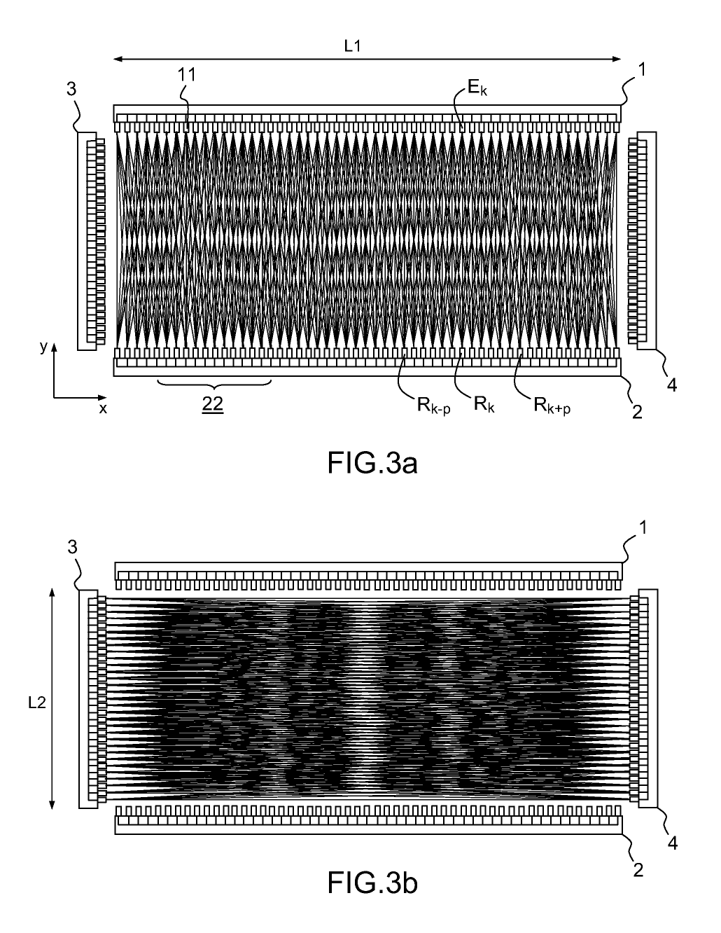

FIGS. 3a and 3b illustrate a scanning mode applied by a device according to the invention. This scanning mode makes it possible to both eliminate the ambiguity in the detection of the two touches 7, 8, illustrated by FIG. 2, while making it possible to ensure the predictability of the control. It can be applied to a device of the type of FIGS. 1a and 1b, that is to say without changing the hardware infrastructure of the display device.

The scanning of the light beams of a device according to the invention comprises at least the following two features:
each emitter is associated with a number of receivers in the horizontal scan, on x, and in the vertical scan, on y;
the entire space is scanned, that is to say that all the emitters of a group 1, 3 emit in succession, the scanning cycles are initiated according to predetermined, set time periods, each period encompassing the duration of the horizontal scan and of the vertical scan as well as the scanning result processing time, this processing computing and transmitting the central position of the touches 7, 8 to control interfaces. A scanning cycle comprises a complete scan of constant duration according to the first group 1 of emitters and a complete scan of constant duration according to the second group 3 of emitters.

In the examples of scans illustrated by FIGS. 3a and 3b, an emitter 11 is associated, for example, with 13 successive receivers. The positions of the associated receivers can be identified by the positions −6 to +6, where the position 0 is the position of the receiver placed facing the emitter.

The number of associated receivers depends notably on the geometry of the screen and notably on the dimensions of the frame. Thus, by considering that a group comprises N emitters and its associated group N receivers, an emitter Ek, of number k, is associated with a certain number of receivers, contained between Rk−p and Rk+p, where the Rk+i, −p≦i≦p, represent the set of associated receivers. It would be possible to envisage a solution where the group of receivers comprises a number M of receivers different from the number N of emitters. It would also be possible to envisage the case where the associated receivers are not contiguous.

During the horizontal scan, on the x axis, the emitters 11 of the first group of emitters are activated in succession. The receivers can be activated permanently, at least for the scanning duration. The infrared beams are frequency-modulated which makes it possible to differentiate the emitted beam intended for the associated receivers 22 from a disturbance external to the frame. For each emitter, it is possible to provide a number of emission oscillations. Two oscillations are theoretically sufficient to characterize the modulation. In practice, an emission produced by an emitter may comprise ten or so oscillations.

The process is the same for the vertical scan, on the y axis. Thus, a fine scan is obtained, as FIGS. 3a and 3b show, where all the rays emitted and received 20 are stored in a dedicated space, for example in a table. A ray that is emitted and received can in fact be characterized unequivocally by the number of its emitter and the number of its receiver. The pair (k, k+j) thus corresponds to a ray emitted by the emitter Ek and received by the receiver Rk+j.

FIGS. 3a and 3b correspond to the case where there is no touch on the screen. In this case, no beam is interrupted. All the emitted beams are received, and therefore all the possible pairs (k, k+j) are stored during the scan, −p<j<p.

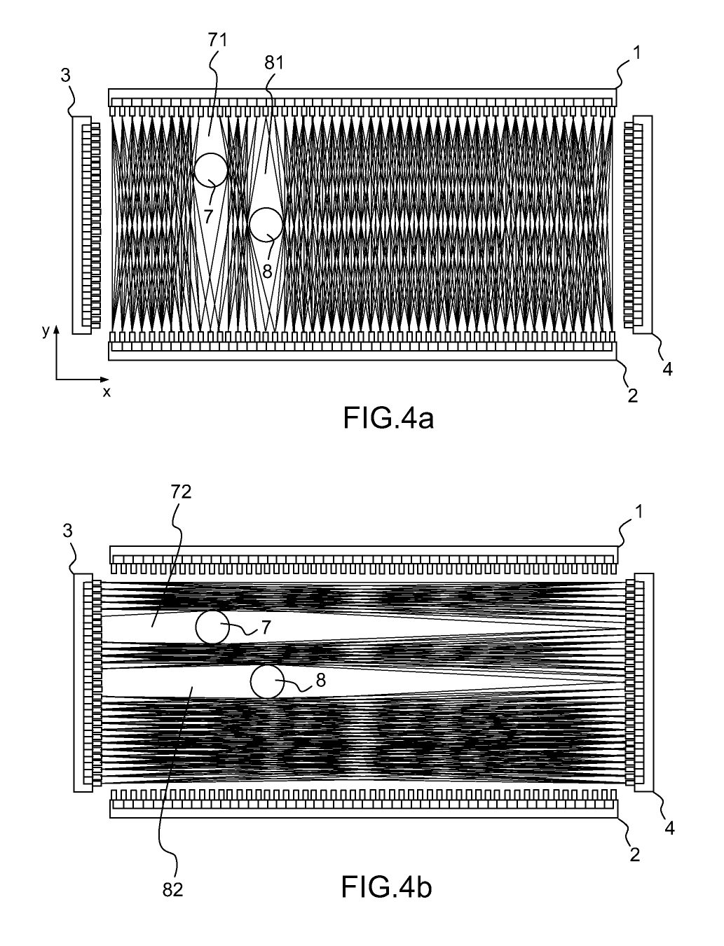

FIGS. 4a and 4b illustrate the scan in the case of a multitouch application on the touch frame. This is an example with two touches 7, 8, the positions being the same as in the case of FIGS. 1a and 1b. The touches provoke ray interruptions creating shadow areas. The interrupted rays are identified by their pair (k, k+j) corresponding to the emitter Ek and to the receiver Rk+j, and incorporated in the processing.

A set of pairs of numbers (k, k+j) absent from the storage space is thus obtained. These absent pairs define absent light rays and therefore spaces 71, 72, 81, 82 not scanned by these light rays, two unscanned spaces 71, 81 for the scan on x and two unscanned spaces 72, 82 for the scan on y. An unscanned space, on x or on y, is a space where at least one ray is stopped by a touch 7 or 8. In other words, it can be stated that such a space contains a touch.

To obtain the absent pairs in the direction, and therefore the spaces in the shadow 71, 81, the set of all the pairs (k, k+j) stored during the scan on x is compared for example with the set of all the possible pairs in that direction. The set of all the possible pairs (k, k+j)corresponds to the set of all the possible transmitter-receiver combinations (Ek, Rk+j) where Rk+j is associated with Ek, that is to say Rk+j is intended to pick up one of the rays emitted by Ek.

All these pairs are predetermined, by virtue of the a priori knowledge of the receivers associated with each emitter and therefore of all the possible rays. The totality of the possible pairs corresponds to the complete scan of the screen in the direction x, with no ray interruption. The process is the same in the direction y.

Once the scans on x and on y have been performed, the processing means perform a two-dimensional analysis. From these data, it is possible to reconstruct the unscanned spaces 71, 81 on x and the unscanned spaces 72, 82 on y, and then their intersections are performed.

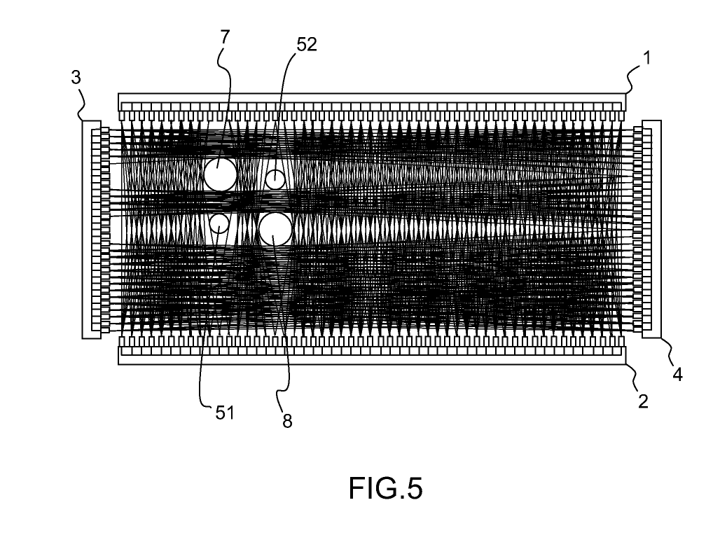

FIG. 5 shows how the positions of the touches 7 and 8 can be obtained from the spaces 71, 72, 81, 82 defined previously. The intersections of these four spaces define four areas of unequal dimensions. As seen previously, two correspond to the touches and the other two are phantom points. The two areas 7, 8 of larger dimensions can correspond only to real touches. It will be noted that the two other areas 51, 52 have the same central positions as the phantom touches 70, 80 of FIG. 2, but this time have a smaller dimension making it possible to eliminate them.

In one case of use, it will be possible, for example, to apply this invention to a 12″ screen, the scanning speed would be 40 scans per second. The scanning cycles would comprise the scan on x and the scan on y, and would, for example, be initiated every 25 ms. With the preceding scanning speed, sufficient time would remain for the processing means to define the position of the touches according to the process described previously and transmit these positions, for example, to display interfaces.

Other display types can be interfaced with a device according to the invention, such as, for example, projected images.

The invention has been described for a touch control intended for display, but it can be applied to other applications requiring touch control.

Notably advantages of the invention are that it is predictable, simple to implement and that it is cost effective. In practice, there is no need to modify the existing hardware infrastructure, only the processing is modified. It is thus possible to perform a simple software upgrade or modification when an electronic modification is not needed.

1. A touch control device of the type with infrared barriers comprising at least one frame, a first group of infrared ray emitters facing a first group of receivers in a first direction x and a second group of infrared ray emitters facing a second group of receivers in a second direction y, said groups framing a touch interaction space, the scanning of this space being performed by the successive activations of the emitters of the first group then of the second group, the intrusion of an opaque object, called touch, inside the touch interaction space provoking an interruption of emitted rays, wherein, for the first group of emitters and for the second group of emitters:
each emitter is associated with a subgroup of receivers intended to pick up the rays emitted by said emitter, the receivers of said subgroup being arranged facing said emitter, the set of all the pairs scanned being stored, where k represents the number of an emitter in the group and k+j the number of one of its associated receivers;
the scanning cycles are initiated according to set time periods, a scanning cycle comprising a complete scan of constant duration according to the first group of emitters and a complete scan of constant duration according to the second group of emitters, a pair being assigned to each ray emitted and received, k being the number of the emitter and k+j the number of the receiver;
all of the emitted rays not received, identified by their pairs k, k+j, defining one or more shadow areas, the detection of one or more touches being performed by the analysis of these areas by said processing means.

2. The device according to claim 1, wherein −p<j<p, where p is a positive integer, j taking some or all of the values between −p and p, 2p−F1 being less than the number of receivers of the group.

3. The device according to claim 1, wherein a first series of shadow areas is obtained in the direction x, and a second series of shadow areas is obtained in the direction y, an unscanned space containing at least one touch, said analysis being performed on the space or spaces obtained by the intersection of the first and second series of areas.

4. The device according to claim 3, wherein said processing means differentiate the real touches from phantom touches on a criterion of sizes, forms, extent of these shadow areas and/or by comparison with the preceding state of the touches.

5. The device according to claim 1, wherein the emitted rays are frequency-modulated, the ray received by a receiver Rk+j being associated with an emitter Rk according to the number of said receiver Rk+j and the verification of said modulation.

6. The device according to claim 1, wherein the processing means are incorporated in said device, said processing means transmitting the positions of the touches to display interfaces.

7. The device according to claim 1, wherein it can be used to equip an aircraft cockpit.

8. A touch control method of the type with infrared barriers, said method using a first group of infrared ray emitters facing a first group of receivers in a first direction x and a second group of infrared ray emitters facing a second group of receivers in a second direction y, said groups framing a touch interaction space, the scanning of this space being performed by the successive activations of the emitters of the first group then of the second group, the intrusion of an opaque object, called touch, inside the touch interaction space provoking an interruption of emitted rays, for the first and for the second groups of emitters:
each emitter Ek having associated with it a subgroup of receivers Rk−p to Rk+p intended to pick up the rays emitted by said emitter, the receivers of said subgroup being arranged facing said emitter, the set of all the pairs k, k+j scanned being stored, where k represents the number of an emitter in the group and k+j the number of one of its associated receivers;
the scanning cycles are initiated according to set time periods, a scanning cycle comprising a complete scan of constant duration according to the first group of emitters and a complete scan of constant duration according to the second group of emitters, a pair k, k+j being assigned to each ray emitted and received, k being the number of the emitter and k+j the number of the receiver;
all of the emitted rays not received, identified by their pairs k, k+j, defining one or more shadow areas, the detection of one or more touches being performed by an analysis of these areas.

9. The method according to claim 8, wherein −p<j<p, where p is a positive integer, j taking some or all of the values between −p and p, 2p−F1 being less than the number of receivers of the group.

10. The method according to claim 8, wherein a first series of shadow areas is obtained in the direction x, and a second series of shadow areas is obtained in the direction y, an unscanned space containing at least one touch, said analysis being performed on the space or spaces obtained by the intersection of the first and second series of areas.

11. The method according to claim 10, wherein the real touches are differentiated from phantom touches on a criterion of sizes, forms, extent of these shadow areas and/or by comparison with the preceding state of the touches.

12. The method according to claim 8, wherein the emitted rays are frequency-modulated, the ray received by a receiver Rk+j being associated with an emitter Rk according to the number of said receiver Rk+j and the verification of said modulation.
